(19) United States
(12) Patent Application Publication
(10) Pub. No.: US 2005/0022124 A1
(43) Pub. Date: Jan. 27, 2005

(54) Method and system for recognizing questionnaire data based on shape

(76) Inventor: William Patrick Tunney, Montreal (CA)

Correspondence Address: KENYON & KENYON, 1500 K STREET, N.W., SUITE 700, WASHINGTON, DC, 20005, US

(21) Appl. No.: 10/625,621

(22) Filed: Jul. 24, 2003

(51) Int. Cl. G06F 17/21

(52) U.S. Cl. 715/541

(57) ABSTRACT

A method and system for recognizing questionnaire data based on shape. An embodiment of a method includes receiving a set of coordinates from a capture device, the set of coordinates indicating a shape made on a questionnaire without the use of a graphical user interface, and mapping the shape to a questionnaire answer. The method enables a processor to accurately and quickly determine questionnaire answers entered on a piece of paper attached to the capture device, independent of paper orientation or movement while filling out the questionnaire. Exemplary applications include a field survey and inventory.

### BACKGROUND

Handwriting recognition software has made it possible to digitally capture handwriting and transform it into digital characters using an input capture device and a computer. The capture device may be a flat panel device that allows a user to enter normal handwritten scribbles onto a piece of paper attached to the capture device while information about the coordinates of the pen strokes is digitally recorded by the capture device. The capture device can later upload the digitally recorded handwritten scribbles into a computer where an uploading program receives and stores the handwriting scribbles in memory, resulting in two copies of a document, namely the original handwritten version and a second, digitally encoded version.

Digital handwriting capture is useful when data must be entered into a computer program for later processing, but original handwritten copies must be retained for legal or verification purposes. In these instances, it would be helpful to have handwriting automatically transformed into digital characters and transferred to a computer program without manual data entry. This may be achieved by placing a printed paper form with clearly defined input fields on a capture device, digitally capturing the handwritten scribbles, e.g., drawings and text characters, in these input fields on the capture device, and uploading the digital scribbles to the computer. A recognition program may then interpret the digitally recorded handwritten scribbles in these input fields and transform them into a digitally encoded representation, which can be automatically entered into the computer program in the same manner as if the scribbles were manually entered via a keyboard.

An exemplary application for digital handwriting capture is a questionnaire. A typical questionnaire is a printed paper form containing a collection of questions and a set of answers from which to choose for each question. Each answer has a check box next to it. A printed questionnaire may be attached to the capture device and the device pen used to check a chosen answer for each question in the questionnaire. As each question is answered, the capture device digitally captures the pen strokes. The format of the captured pen strokes may be a time-ordered sequence of (x,y) coordinates, a sequence of vector coordinates (x,y,t), or any other format capable of indicating when and where on the capture device pen strokes were made.

At the completion of the questionnaire, the user has both the printed questionnaire and the digital capture data. The paper may be retained as proof that the questionnaire was answered (including an optional signature) and the capture data may be transferred from the capture device to a computer for later processing, avoiding manual data entry.

In order for the computer to determine what the intended answer is and to couple that answer with its question, the computer stores a master template of the questionnaire, including the spatial coordinates on the capture device where each answer's check box is expected to be. Accordingly, when the capture data is uploaded to the computer, the computer simply matches the capture data against the template to determine what the answer is and to which question it belongs.

However, a problem occurs when the questionnaire is not placed exactly in a specified position on the capture device. In this case, the coordinates of the checks made on the questionnaire may not match the coordinates on the template at all, invalidating the questionnaire. Even worse, the checks may match the wrong coordinates on the template, resulting in the almost undetectable error of an answer matched with the wrong question.

Furthermore, even if the questionnaire is placed exactly in the specified position on the capture device, the questionnaire may shift while the user completes the questionnaire. In this case, the computer may correctly match some of the captured data to the template and other data not at all, resulting in an incomplete questionnaire. Or worse, some of the data may be matched to the correct coordinates and other data matched to incorrect coordinates, again resulting in an answer matched with the wrong question.

Because of the nature of questionnaire work, it is virtually impossible to ensure that the questionnaire is placed in an exact position on the capture device or that the questionnaire does not shift its position on the capture device. Questionnaires are rarely taken in an office, but rather on the street or in malls, where a stationary environment is not available.

Some systems have tried to solve these problems by providing graphical user interfaces that display the questionnaires. In these systems, a more complex input/output device than the capture device must be used to display the graphical user interfaces. Such a device could be expensive and too bulky to carry, particularly for field surveys, field inventory, etc., for which the capture device is ideally suited.

Accordingly, there is a need in the art for a simple and natural way to accurately recognize questionnaire data entered by a user onto printed paper forms attached to capture devices, independent of the position and/or movement of the questionnaire on the capture device.

### SUMMARY OF THE INVENTION

Embodiments of the present invention provide a simple and natural method to recognize questionnaire data. These embodiments provide questionnaire answers by making marks on a questionnaire corresponding to the intended answer, while a capture device captures when and where on the questionnaire the marks were made. A method includes a processor receiving capture data from the capture device, where the capture data is captured simultaneously with writing made on paper. The method further includes the processor detecting a shape of the writing on the paper and comparing the detected shape with a plurality of shapes stored in memory in association with the paper. The method further includes the processor, upon a match of the detected shape with one of the stored shapes, retrieving from memory the data, e.g., a questionnaire answer, associated with the stored shape and then storing the retrieved data as the writing made on the paper. The capture data is advantageously generated by simply using a piece of paper and the capture device without having to rely on more complex, bulky devices with graphical user interfaces.

Embodiments of the present invention also provide a system through which questionnaire data may be recognized. The system may include a memory and a processor for receiving capture data corresponding to a set of marks made on a questionnaire attached to a capture device and mapping the capture data to a questionnaire answer.

### BRIEF DESCRIPTION OF DRAWINGS

FIG. 1 is an exemplary computer network used to recognize questionnaire data based on shape information according to embodiments of the present invention.

FIG. 2 is an exemplary computer used to recognize questionnaire data based on shape information according to embodiments of the present invention.

FIG. 3 is an exemplary paper data form that includes a questionnaire to be filled out according to an embodiment of the present invention.

FIG. 4 is an exemplary data capture format according to an embodiment of the present invention.

FIG. 5 is a flowchart of an embodiment of a method according to the present invention.

### DETAILED DESCRIPTION

Embodiments of the present invention provide a method and system for recognizing questionnaire data from a paper data form (e.g., a questionnaire) attached to a capture device. The questionnaire may include a collection of questions and one or more answer choices for each question. Questionnaire answer choices may include the answers themselves and a plurality of uniquely shaped check boxes, where each answer has a check box associated with it. A check box in embodiments of the present invention is not limited to a box shape that has to be checked, but may include any shape and may be marked in any manner according to the particular application to indicate that the box has been selected. In these embodiments, a user may simply fill in one of the uniquely shaped boxes corresponding to her intended answer to a question. The capture device may digitally capture the pen strokes the user makes when filling in the box and upload this capture data to a computer for questionnaire data recognition according to embodiments of the present invention. Exemplary applications of these embodiments include field surveys, field inventory, and other applications where paper forms are the predominant way data is recorded and device portability and ease of use are preferable.

In embodiments of the present invention, the computer's processor may receive the capture data from a capture device to which a paper data form was previously attached. The capture data format may be a time ordered sequence of (x,y) coordinates, indicating the shape a set of marks (or pen strokes) made to fill in the correct answer on the data form. The processor may then detect the shape that the set of marks made based on the coordinates. This detected shape may then be compared to a plurality of predefined unique shapes stored in the computer's memory that are expected to be on the data form. The predefined shape that matches the detected capture shape may be determined and the questionnaire answer corresponding to that predefined shape stored in memory for later use; hence, the questionnaire data is recognized. In an alternate embodiment, the capture data format may be a sequence of vectors (x, y, t) or any format that appropriately represents the user's pen strokes.

Instead of having to rely on precise placement or complete immobility of a questionnaire on the capture device, embodiments of the present invention may be able to use unique shapes resolved from the capture data to recognize the correct questionnaire answers. The questionnaire may be placed anywhere on the capture device, as long as the pen strokes may still be captured, because the computer recognizes an intended answer based on the check box shape, not position. And, the questionnaire may shift many times on the capture device between answer selections without penalty. Indeed, the questionnaire may shift such that a check box may be filled in at the exact location on the capture device as an previously filled-in check box. However, the unique shapes of the two check boxes allows the computer to easily distinguish between them. The computer may use any known shape recognition techniques, e.g., mathematical models, to detect the check box shapes from the pen strokes. Accordingly, these embodiments advantageously provide a simple and natural way to accurately recognize questionnaire data. Hence, data errors are reduced and data entry speed is improved.

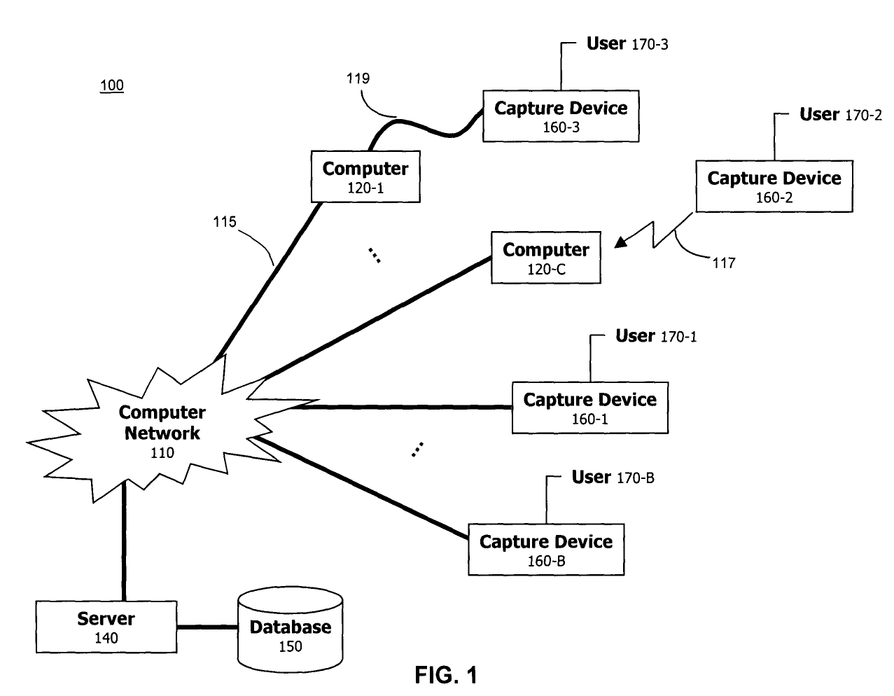

FIG. 1 shows an embodiment of an exemplary network that may be used to implement embodiments of the present invention. The exemplary network system 100 may include, but is not limited to, a computer network 110, computers 120-1 through 120-C, where C is an integer, capture devices 160-1 through 160-B used by users 170-1 through 170-B, where B is an integer, to input questionnaire data, a server 140, and a database 150 for storing various questionnaire information used by the computers. These components may be linked to the network 110 via network links 115. The network 110 may be a LAN, WAN, Internet, or any like structure capable of connecting components and transmitting data. The network links 115 may include physical wiring, wireless connections, or any like transmission configuration capable of transmitting data. Alternatively, a capture device 160 may be directly linked via a wireless link 117, a COM cable 119, or any like connector, to a computer 120.

The capture device used in embodiments of the present invention may include a portable input device whose appearance and operation resembles that of a traditional clipboard. The capture device may include a flat panel onto which a piece of paper may be attached and pens used to write on the paper thereby entering data to the capture device. The paper generally replaces a graphical user interface that is included in most input devices. So, typically, the capture device does not include a graphical user interface. The pen strokes made on the paper may be stored in memory on the capture device for later uploading to a computer via a modem, cable, or other transmission device in communication with a port of the capture device. An example of the capture device is the CrossPad™ manufactured by IBM.

In an embodiment, the capture device may include software for interacting with a user and for uploading capture data to the computer. The capture device may include a series of built-in buttons that may be configured to initiate given commands. For example, capture data may be uploaded to the computer via the wireless link, COM cable, or the like, by the user pressing some of the buttons to initiate the upload process. After the upload completes, the user may delete the capture data from the capture device. The capture device may include a small text-based display to show short text messages to the user.

In an alternate embodiment, the capture device may include local intelligence for performing recognition and uploading the recognized data to the computer for further processing.

Since digital handwriting capture is not limited to physical flat panel devices, in another alternative embodiment the capture device may include electronic reusable paper, for example. Electronic reusable paper is designed to have the look and feel of normal paper, except that it contains tiny sensor network technologies that provide digital display and capture of handwritten scribbles. Similar to a flat panel device, data can be captured, except that in the case of electronic reusable paper that data is collected and stored by the paper itself. Data collection from electronic reusable paper may be implemented in many ways, including attaching the paper to a clipboard containing the electronics required to retrieve data from the electronic reusable paper and forwarding the data obtained using standard methods. An example of electronic reusable paper is SmartPaper manufactured by Gyricon LLC.

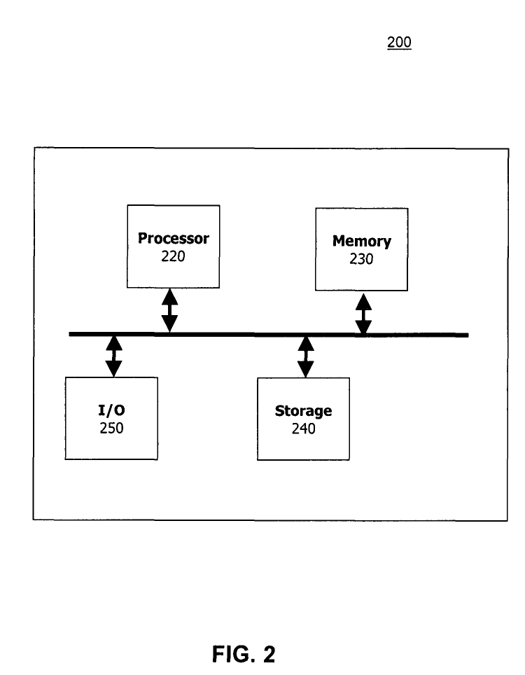

FIG. 2 is a block diagram of an exemplary computer that can implement embodiments of the present invention. The computer 200 may receive capture data from the capture device according to embodiments of the present invention. The computer 200 may include, but is not limited to, a processor 220 provided in communication with a system memory module 230, a storage device 240, and an I/O device 250. The processor 220 may perform data recognition with the capture data received from the capture device. The memory 230 may store program instructions to be executed by the processor 220 and also may store variable data generated pursuant to program execution. In practice, the memory 230 may be a memory system including one or more electrical, magnetic, or optical memory devices. The I/O device 250 may include a docking station for interface to the capture device 160 to receive the capture data and transmit any other appropriate data between the capture device 160 and the computer 200.

In embodiments of the present invention, a paper form may have printed thereon data, including questions and their answer choices. Each answer choice may include a uniquely shaped check box that a user fills in when selecting that answer. This shape may be captured by the capture device and later uploaded to a computer for processing. Hence, the computer may determine questionnaire data based on these unique shapes.

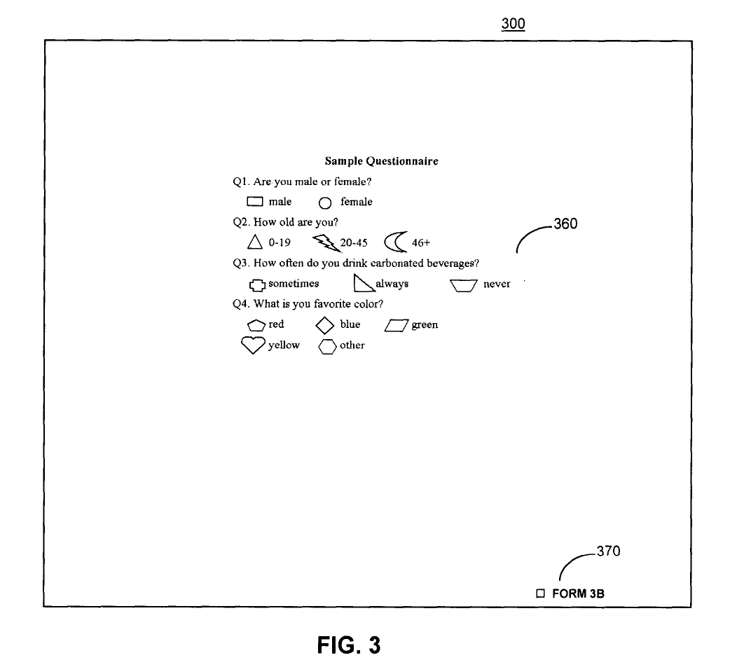

FIG. 3 is an example of a paper data form in which questionnaire answers are printed with uniquely shaped check boxes as described. In this example, the data form 300 may include, but is not limited to, a questionnaire 360 to be filled out where a shape appears only once on the questionnaire 360. The data form 300 may further include the identification 370 of the data form.

The data form 300 may be attached to the capture device 160 and an answer for each question in the questionnaire 360 chosen by filling in the answer's check box. The coordinates of the marks made when filling in the check box may be recorded on the capture device 160 and later uploaded to the computer 120 for processing according to embodiments of the present invention. A check box may be filled in by shading the entire box. However, the check box need not be filled in perfectly, as any well-known shape recognition technique may correctly identify the shape from imperfect or incomplete capture data.

In systems with multiple data forms, identification 370 of the data form may be uploaded to the computer 120 so that the computer 120 may retrieve the appropriate predefined shapes for that data form. In one embodiment, the form identification 370 may have a check box associated with it that the user checks. The position of the filled-in identification box may indicate to the computer 120 which data form is being used. The position of the identification box may include some tolerance to allow for data form shifting.

It is to be understood that the form is not limited to a shape appearing only once per form, as shown in FIG. 3. The shape may be repeated at different intervals on the form as long as the same shape does not appear in the same question. For example, in an alternate embodiment, the locations on the questionnaire of the repeated shape may be spaced sufficiently apart such that a shift in the paper still could not result in confusing the answers associated with the repeated shape. For example, a square check box may appear in Question 1, but not again until Question 15, so there is a large gap between the two square check boxes. In this instance, the computer may use the shape alone or both the shape and position of the check boxes to recognize questionnaire data.

Alternatively, the paper form may be attached to the capture device in some way to minimize movement. In this case, the gap between repeating shapes may be reduced. Again, the computer may use both the shape and position of the check boxes to recognize questionnaire data. For example, a border or like markers may be printed on the face of the capture device indicating where the data form should be attached. Or, the data form may have printed in each corner a hash mark or like markers. A user first would write on the paper form at the hash marks prior to marking the form with the user's answers. The coordinates of these hash marks may be captured and uploaded to the computer where used as reference points for determining the positions of the questionnaire answers on the form. Once the positions are determined, the computer may then use the shape to determine the questionnaire data. Conversely, the computer may use the shape to determine the questionnaire data and then use the position of the shape on the form for verification.

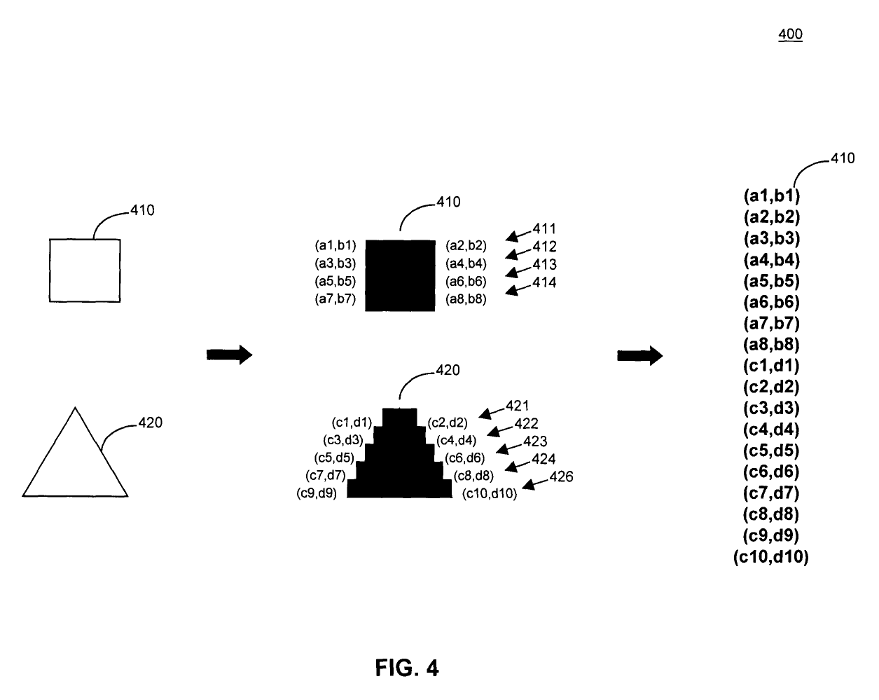

FIG. 4 illustrates an example of the capture data format that may be used in embodiments of the present invention. In this example, the user filled in the square check box 410 indicating a selection of the answer having the square check box. In this example, the user made 4 pen strokes 411-414 to fill in the square check box 410. The capture device digitally captured the pen strokes 411-414 as time ordered coordinates. Here, (a1,b1) and (a2,b2) are the end coordinates for the first pen stroke 411, (a3,b3) and (a4,b4) are the end coordinates for the second pen stroke 412, (a5,b5) and (a6,b6) are the end coordinates for the third pen stroke 413, and (a7,b7) and (a8,b8) are the end coordinates for the final pen stroke 414. The user filled in the check box 410 left to right, top to bottom. Hence, the corresponding coordinates were uploaded to the computer in that order, as illustrated by 410. The processor 220 may calculate the shape these pen strokes made by detecting the perimeter of the shape formed by end coordinates of the pen strokes. The processor 220 may further use the ordering as indication of when the marks were made, i.e., relative to each other.

Similarly, the user filled in the triangle check box 420 indicating a selection of the answer having the triangle check box. In this example, the user made 5 pen strokes 421-426 to fill in the triangle check box 420. The capture device digitally captured the pen strokes 421-426 as time ordered coordinates (c1,d1) through (c10,d10) and uploaded them to the computer in that order, as illustrated by 410.

It is to be understood that the left to right, top to bottom order of the pen strokes is for explanation purposes only. The pen strokes may be made in any random order, orientation, position, or manner to fill in the check box.

In this example, the capture device 160 captures the two end point coordinates of the pen strokes. The capture device 160 may digitally capture additional (x,y) coordinates along the trajectory of the drawn line, depending on the application.

Embodiments of the present invention represent shape information as end point coordinates of the pen strokes used to fill in the shape. It is to be understood that the shape information may be represented in this or any other suitable manner.

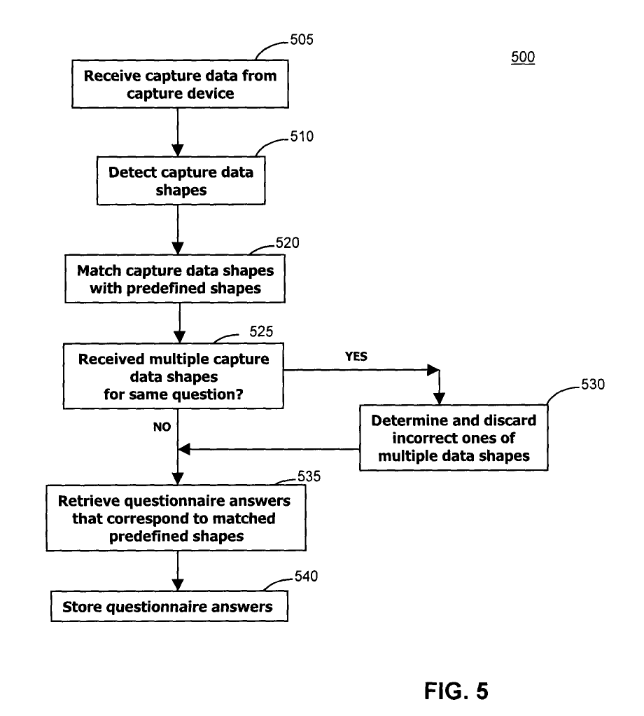

FIG. 5 is a flowchart of an embodiment of a method for recognizing questionnaire data according to the present invention. The processor 220 may receive (505) capture data from the capture device 160. As stated previously, the capture data may include, but is not limited to, a time-ordered set of coordinates representing a shape that a set of marks made to fill in a check box of a chosen questionnaire answer. The processor may then use shape recognition techniques to detect (510) the shape made by the set of marks. Next, the processor 220 may compare (520) the detected shape with a set of predefined unique shapes in memory 230 or storage 240 to find a match for the capture data. The predefined shapes may define the unique shapes of check boxes expected to be on the questionnaire.

In a system where a variety of questionnaires may be used, the processor 220 may also receive the form identification from the capture device 160. Each questionnaire may have a check box for identification. The captured form identification may be indicated by a set of coordinates, vectors, etc., indicating the set of marks made on the paper data form to check the identification check box. Prior to retrieving the predefined questionnaire shapes, the processor 220 may detect the location of the form identification marks and then identify the form being used based on the marks' location. The processor 220 may then determine the predefined shapes in memory 230 or storage 240 based on the form identification and compare (520) the detected questionnaire shapes with these determined predefined shapes.

Embodiments of the present invention provide a way for the user to change an answer to a question by crossing out the incorrect answer. When the user fills in a first answer to a question, later changes her mind, crosses out the first answer, and then fills in a second answer to the same question, the processor 220 may correctly identify the second answer as the intended one. Hence, a filled-in shape having thereon cross marks may be discarded as an incorrect answer and the filled-in shape recorded after the recording of the cross marks may be identified as the correct answer. Here, the capture device 160 records more than one set of marks for the same question. The capture device 160 records the set of marks for filling in a shape associated with a first answer, the set of marks for crossing out the first shape, and the set of marks for filling in a shape associated with a second answer.

For example, in the questionnaire 360 of FIG. 3, the user may first fill in the pentagonal-shaped check box for Q4. The user may later change her mind and cross out the pentagonal-shaped check box. The user may then fill in the diamond-shaped check boxes for Q4. Accordingly, the capture device 160 records a set of coordinates for the pentagonal-shaped check box and a set of coordinates for the diamond-shaped check box. The capture device 160 also records a set of marks for the cross marks. The processor 220 then receives the multiple sets of coordinates and detects the two shapes and the cross marks. As previously described, the capture device 160 captures the time when a mark was made, either implicitly, in the ordering of the sequence of (x,y) coordinates, or explicitly, in the vector coordinates (x,y,t), for example. So, using the coordinate and time data, the processor 220 determines that the cross marks were made after and on top of the pentagonal-shaped check box. The processor 220 determines that the pentagonal-shaped check box belongs to the incorrect answer and discards the pentagonal-shaped check box and the cross mark coordinates. Using the time data, the processor 220 then determines that the diamond-shaped check box was filled in after the crossed-out pentagonal-shaped check box; hence, the diamond-shaped check box belongs to the intended answer. So, the processor 220 solves this problem of multiple sets of coordinates by determining (525, 530) which of the capture data shapes was crossed out and discarding the crossed out shape.

The processor 220 may determine that the multiple capture data shapes belong to the same question by searching the predefined shapes for each question. In one embodiment, the predefined shapes may be grouped into logical sets by question (i.e., one set of shapes per question). For example, in the questionnaire 360 in FIG. 3, the rectangle and circle shapes may be grouped for Q1, the triangle, lightning bolt, and crescent shapes may be grouped for Q2, etc. These groupings may be represented in memory 230 or storage 240 by common flags, variables, or any identifier capable of indicating the grouping. Accordingly, the processor 220 may compare all the capture data shapes with the logical sets and perform the multiple shape analysis when multiple matches within a logical set are found.

Next, the processor 220 may retrieve (535) from memory or storage the answers associated with the predefined shapes that match the captured shapes. The processor 220 may then store (540) the questionnaire answers as the ones the user marked on the form.

The processor 220 may alternatively retrieve the predefined shapes from memory or storage, one at a time or together, prior to the comparison with the captured shapes and then store the questionnaire answers that match the captured shapes as the ones the user marked on the form.

In an alternate embodiment, the capture device 160 may perform the data capture, the shape identification, and the questionnaire answer determination. After which, the capture device 160 may upload the answers to the computer 120 for further use or storage.

In another alternative embodiment, a user may trace the perimeter of the check boxes rather than fill them in. The capture device 160 may then record the pen strokes corresponding to the shape perimeter. The processor 220 may use any shape recognition techniques to determine the shape of the check box.

Embodiments of the present invention may be implemented using any type of computer, such as a general-purpose microprocessor, programmed according to the teachings of the embodiments. The embodiments of the present invention thus also includes a machine readable medium, which may include instructions used to program a processor to perform a method according to the embodiments of the present invention. This medium may include, but is not limited to, any type of disk including floppy disk, optical disk, and CD-ROMs.

It may be understood that the structure of the software used to implement the embodiments of the invention may take any desired form, such as a single or multiple programs. It may be further understood that the method of an embodiment of the present invention may be implemented by software, hardware, or a combination thereof.

The above is a detailed discussion of the preferred embodiments of the invention. The full scope of the invention to which applicants are entitled is defined by the claims hereinafter. It is intended that the scope of the claims may cover other embodiments than those described above and their equivalents.

1. A method comprising:
receiving capture data from a capture device, wherein the capture data is captured simultaneously with writing made on a paper;
detecting a shape of at least one writing on the paper;
comparing the detected shape with one of a plurality of shapes stored in memory in association with the paper;
on a match, retrieving from memory data associated with the matching shape; and
storing the retrieved data as the writing made on the paper.

2. The method of claim 1, wherein the capture data is a set of time ordered coordinates (x,y) of the writing on the paper.

3. The method of claim 1, wherein the capture data is a set of vector coordinates (x,y,t) of the writing on the paper.

4. The method of claim 1, wherein the retrieved data includes an answer to a question in a questionnaire.

5. A method comprising:
receiving a set of coordinates from a capture device, the set of coordinates indicating a shape made on a paper form with a set of marks without the use of a graphical user interface; and
mapping the shape to an answer to a question.

6. The method of claim 5, further comprising:
identifying the shape from the set of coordinates.

7. The method of claim 5, wherein the set of coordinates indicates when and where the set of marks was made.

8. The method of claim 5,
wherein the paper data form is attached to the capture device, the data form including a plurality of check boxes, each box having a unique shape and corresponding to an answer to a question.

9. The method of claim 8, wherein the shape is made by filling in one of the check boxes.

10. The method of claim 9, further comprising:
discarding a mistakenly filled-in check box, including
receiving the set of coordinates corresponding to the mistakenly filled-in box and the set of coordinates corresponding to a cross-out line,
determining that the cross-out line was drawn across the mistakenly filled-in box on the paper form, and
eliminating the set of coordinates corresponding to the mistakenly filled-in box and the set of coordinates corresponding to the cross-out line.

11. The method of claim 8, wherein the shape is made by tracing the perimeter of one of the check boxes.

12. The method of claim 5, wherein the mapping includes:
retrieving from memory predefined shapes expected to be made on the capture device;
comparing the indicated shape to the predefined shapes;
determining which of the predefined shapes is a match to the indicated shape; and
storing the questionnaire answer corresponding to the determined predefined shape.

13. The method of claim 12, further including:
receiving an identification of the paper data form; and
retrieving from memory the predefined shapes based on the identification.

14. A system, comprising:
a memory;
a processor in communication with the memory, the processor executing a set of instructions to:
receive capture data corresponding to a set of marks made on a questionnaire attached to a capture device, and
map the capture data to a questionnaire answer.

15. The system of claim 14, wherein the capture data indicates when and where the set of marks was made on the questionnaire.

16. The system of claim 14, wherein the set of marks represents a unique shape.
